(19) United States
(12) Patent Application Publication
(10) Pub. No.: US 2021/0280355 A1
(43) Pub. Date: Sep. 9, 2021

(54) COIL DEVICE

(71) Applicant: TDK CORPORATION, Tokyo (JP)

(72) Inventors: Kosuke KUNITSUKA, Tokyo (JP); Keigo HIGASHIDA, Tokyo (JP); Emi ITO, Tsuruoka-city (JP)

(73) Assignee: TDK CORPORATION, Tokyo (JP)

(21) Appl. No.: 17/189,494

(22) Filed: Mar. 2, 2021

(30) Foreign Application Priority Data
Mar. 4, 2020 (JP) 2020-036732

(51) Int. Cl. H01F 27/28; H01F 27/24; H01F 27/29

(52) U.S. Cl. CPC H01F 27/2823; H01F 27/29; H01F 27/24

(57) ABSTRACT

A coil device includes a core having a winding core portion and flange portions and formed in end portions of the winding core portion, a first winding portion formed by winding a first primary wire and a first secondary wire around the winding core portion, and a second winding portion formed by winding a second primary wire and a second secondary wire around the winding core portion. The second winding portion is formed with an alternating winding region where the second primary wire and the second secondary wire are alternately disposed and wound and a continuous winding region where either the second primary wire or the second secondary wire is continuously wound.

### BACKGROUND OF THE INVENTION

### 1. Field of the Invention

The present invention relates to a coil device preferably used as a balun transformer or the like.

### 2. Description of the Related Art

A balun transformer as a coil device mutually converting a balanced signal and an unbalanced signal is described in, for example, JP 2010-93183 A. The balun transformer described in JP 2010-93183 A has a core having a winding core portion and first to third winding portions. In the first winding portion, a first wire (primary winding) is wound in a single layer on the outer peripheral surface of the winding core portion. In the second and third winding portions, second and third wires (secondary windings) are bifilar-wound on the first winding portion.

However, in general, the coil device of the related art is problematic in that its insertion loss tends to increase in a high frequency band of, for example, 100 MHz or more.

### SUMMARY OF THE INVENTION

The present invention has been made in view of such circumstances, and an object of the present invention is to provide a coil device with little insertion loss in a high frequency band.

The present inventors have found that primary and secondary windings wound by a winding method different from the related art lead to a decrease in insertion loss in a high frequency band and have completed the present invention.

In order to achieve the object described above, the coil device according to the present invention includes:

a core having a winding core portion and a flange portion formed in an end portion of the winding core portion;

a first winding portion formed by winding a first primary wire and a first secondary wire around the winding core portion; and

a second winding portion formed by winding a second primary wire and a second secondary wire around the winding core portion,

in which the second winding portion is formed with an alternating winding region where the second primary wire and the second secondary wire are alternately disposed and wound and a continuous winding region where either the second primary wire or the second secondary wire is continuously wound.

In the coil device according to the present invention, the second winding portion is formed with the alternating winding region where the second primary wire and the second secondary wire are alternately disposed and wound and the continuous winding region where either the second primary wire or the second secondary wire is continuously wound. In the case of such a winding method (formation of the alternating winding region as well as the continuous winding region in the second winding portion), each of the alternately disposed second primary wire and second secondary wire is strongly coupled in the alternating winding region. Accordingly, in a high frequency band of, for example, 100 MHz or more, the coupling coefficient between the primary windings and the secondary windings can be increased and a satisfactory magnetic coupling can be obtained between the primary windings and the secondary windings. As a result, according to the present invention, it is possible to realize the coil device with little insertion loss and a reduced leakage inductance in a high frequency band.

Preferably, the first primary wire and the first secondary wire are alternately disposed and wound in the first winding portion. With such a configuration, in the first winding portion, each of the first primary wire and the first secondary wire disposed adjacent to each other is strongly coupled. Accordingly, in the first winding portion, a satisfactory magnetic coupling can be obtained between the first primary wire and the first secondary wire, and the insertion loss in a high frequency band can be effectively reduced.

Preferably, the second winding portion is formed on the first winding portion. In a case where, for example, the number of turns in the second winding portion is smaller than the number of turns in the first winding portion, the winding portion formed in the upper layer is less likely to collapse when the second winding portion is formed on the first winding portion as described above than when the first winding portion is formed on the second winding portion and each of the winding portions can be stably formed.

Preferably, the number of turns of either the second primary wire or the second secondary wire exceeds the number of turns of the other in the second winding portion. With such a configuration, it is possible to form the continuous winding region in the second winding portion by using the winding larger in number of turns and form the alternating winding region in the second winding portion by using the winding smaller in number of turns. As a result, the coupling coefficient between the primary windings and the secondary windings can be increased and a satisfactory magnetic coupling can be obtained between the primary windings and the secondary windings.

Preferably, a wire length of either the second primary wire or the second secondary wire exceeds a wire length of the other in the second winding portion. With such a configuration, it is possible to form the continuous winding region in the second winding portion by using the winding longer in wire length and form the alternating winding region in the second winding portion by using the winding shorter in wire length. As a result, the coupling coefficient between the primary windings and the secondary windings can be increased and a satisfactory magnetic coupling can be obtained between the primary windings and the secondary windings.

Preferably, one end of the first primary wire and one end of the second primary wire are connected via a conductive member and one end of the first secondary wire and one end of the second secondary wire are connected via a conductive member. With such a configuration, each of the connection portion between the first primary wire and the second primary wire and the connection portion between the first secondary wire and the second secondary wire can be used as an intermediate tap.

Preferably, the second primary wire and the second secondary wire are wound in close contact with each other in the alternating winding region, and each turn of the second primary wire or each turn of the second secondary wire is wound in close contact in the continuous winding region. With such a configuration, a magnetic flux is likely to be interlinked with the second winding portion in each of the winding regions and the magnetic coupling between the primary windings and the secondary windings can be enhanced.

Preferably, the alternating winding region and the continuous winding region are formed in close contact with each other. With such a configuration, the turns adjacent to each other in the winding axis direction are wound in close contact with each other in the entire second winding portion, and thus the magnetic coupling between the primary windings and the secondary windings can be effectively enhanced.

The second primary wire and the second secondary wire may be wound apart from each other in a winding axis direction in the alternating winding region, and each turn of the second primary wire or each turn of the second secondary wire may be wound apart in the winding axis direction in the continuous winding region. Also in this case, the leakage inductance in a high frequency band can be decreased and the insertion loss can be reduced as compared with the coil device of the related art.

The continuous winding region may be formed so as to straddle one side and the other side of the alternating winding region in a winding axis direction. Also in this case, the leakage inductance in a high frequency band can be decreased and the insertion loss can be reduced as compared with the coil device of the related art.

### BRIEF DESCRIPTION OF THE DRAWINGS

FIG. 1 is a perspective view of the coil device according to a first embodiment of the present invention;

FIG. 2A is a plan view illustrating the first winding portion of the coil device illustrated in FIG. 1;

FIG. 2B is a plan view illustrating the second winding portion of the coil device illustrated in FIG. 1;

FIG. 3 is a cross-sectional view taken along the X-Z plane of the coil device illustrated in FIG. 1;

FIG. 4 is an equivalent circuit diagram of the coil device illustrated in FIG. 1;

FIG. 5A is a graph showing the frequency characteristic of the insertion loss of the coil device illustrated in FIG. 1;

FIG. 5B is a graph showing the frequency characteristic of the inductance of the coil device illustrated in FIG. 1;

FIG. 6 is a perspective view of the coil device according to a second embodiment of the present invention;

FIG. 7A is a plan view illustrating the first winding portion of the coil device illustrated in FIG. 6;

FIG. 7B is a plan view illustrating the second winding portion of the coil device illustrated in FIG. 6;

FIG. 8 is a cross-sectional view taken along the X-Z plane of the coil device illustrated in FIG. 6;

FIG. 9 is an equivalent circuit diagram of the coil device illustrated in FIG. 6;

FIG. 10A is a cross-sectional view illustrating a modification example of the coil device illustrated in FIG. 3;

FIG. 10B is a cross-sectional view illustrating another modification example of the coil device illustrated in FIG. 3; and

FIG. 10C is a cross-sectional view illustrating yet another modification example of the coil device illustrated in FIG. 3.

### DETAILED DESCRIPTION OF THE PREFERRED EMBODIMENTS

Hereinafter, the present invention will be described based on the embodiments illustrated in the drawings.

### First Embodiment

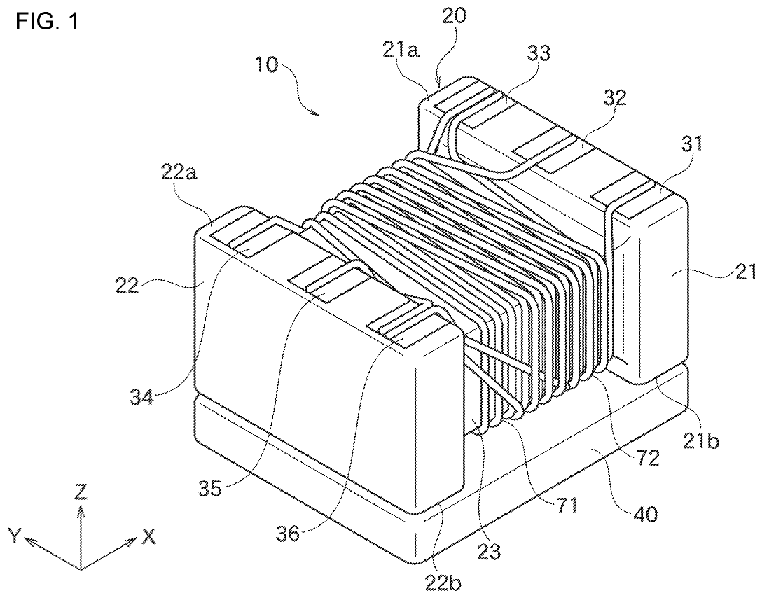

As illustrated in FIG. 1, a coil device 10 according to the first embodiment of the present invention has a drum core 20, a plate core 40, a first winding portion 71, and a second winding portion 72. The coil device 10 is, for example, a balun transformer (balun) and has a function of mutually converting a balanced signal and an unbalanced signal. The coil device 10 is mounted on, for example, an in-vehicle circuit and capable of converting a balanced signal transmitted via a twisted wire such as an unshielded twisted pair (UTP) cable and a shielded twisted pair (STP) cable into an unbalanced signal that can be transmitted via a coaxial cable or the like.

In the following description, the X axis is the direction that is parallel to the winding axis of a winding core portion 23 of the drum core 20 in a plane parallel to the mounting surface on which the coil device 10 is mounted. The Y axis is in a plane parallel to the mounting surface as in the case of the X axis and is a direction perpendicular to the X axis. The Z axis is the normal direction of the mounting surface.

The drum core 20 has the winding core portion 23, a first flange portion 21 formed at one end of the winding core portion 23, and a second flange portion 22 formed at the other end of the winding core portion 23. Although the size of the drum core 20 is not particularly limited, its length in the X-axis direction is 2.0 to 5.0 mm, its length in the Y-axis direction is 1.2 to 5.0 mm, and its length in the Z-axis direction is 0.8 to 4.0 mm.

The winding core portion 23 has a substantially rectangular cross-sectional shape and has a winding axis in the X-axis direction. The cross-sectional shape of the winding core portion 23 is not particularly limited and may be a circular shape, a substantially octagonal shape, or another polygonal shape.

The first flange portion 21 and the second flange portion 22 are disposed so as to face each other and be substantially parallel to each other with a predetermined interval in the X-axis direction. The first flange portion 21 is formed at one end of the winding core portion 23 in the X-axis direction, and the second flange portion 22 is formed at the other end of the winding core portion 23 in the X-axis direction. The outer shapes of the flange portions 21 and 22 are identical to each other and are a substantially rectangular parallelepiped shape that is long in the Y-axis direction. It should be noted that the cross-sectional (Y-Z cross-section) shape of the flange portions 21 and 22 may be a circular shape, a substantially octagonal shape, or another polygonal shape and the cross-sectional shape thereof is not particularly limited.

The plate core 40 is disposed on lower surfaces 21b and 22b of the flange portions 21 and 22. The plate core 40 is a flat and rectangular parallelepiped core having a flat surface and has a function of increasing the inductance of the coil device 10. Although the shape of the plate core 40 that is viewed from the Z-axis direction is a substantially rectangular shape that is long in the X-axis direction, the shape may be a square shape or another shape. The upper surface of the plate core 40 positioned at both ends in the X-axis direction faces the lower surfaces 21b and 22b of the flange portions 21 and 22 and is fixed to the lower surfaces 21b and 22b by means of, for example, an adhesive such as a thermosetting resin. As a result, the plate core 40 forms a closed magnetic path continuous with the drum core 20.

Upper surfaces 21a and 22a of the flange portions 21 and 22 serve as mounting surfaces (ground planes) in a case where the coil device 10 is mounted on a circuit board or the like. On the upper surface 21a of the first flange portion 21, a first terminal electrode 31, a second terminal electrode 32, and a third terminal electrode 33 are respectively formed at predetermined intervals in the Y-axis direction. On the upper surface 22a of the second flange portion 22, a fourth terminal electrode 34, a fifth terminal electrode 35, and a sixth terminal electrode 36 are respectively formed at predetermined intervals in the Y-axis direction.

The terminal electrodes 31 to 36 have the same shape and are formed only on the upper surfaces 21a and 22a. In an alternative example, the terminal electrodes 31 to 36 may be formed so as to straddle the outer end surfaces of the flange portions 21 and 22 and the upper surfaces 21a and 22a. With such a configuration, it is possible to form a solder fillet at a part of the terminal electrodes 31 to 36 formed on the outer end surfaces of the flange portions 21 and 22 when the coil device 10 is mounted on a circuit board.

The terminal electrodes 31 to 36 are made of a conductive member and are configured by, for example, a metal paste baking film or a metal plating film. The terminal electrodes 31 to 36 are formed by performing baking with Ag paste or the like applied to the upper surfaces 21a and 22a of the flange portions 21 and 22 and then forming a plating film by performing electric field plating, electric field-less plating, or the like on the surface thereof.

It should be noted that the material of the metal paste is not particularly limited and examples thereof include Cu paste and Ag paste. In addition, the plating film may be a single layer or a plurality of layers and examples thereof include Cu plating, Ni plating, Sn plating, Ni-Sn plating, Cu-Ni-Sn plating, Ni-Au plating, and Au plating films. The thickness of the terminal electrodes 31 to 36, which is not particularly limited, is preferably 0.1 to 15 μm.

The first winding portion 71 is formed directly on the outer peripheral surface of the winding core portion 23, and the second winding portion 72 is formed on the first winding portion 71. In other words, in the present embodiment, the winding core portion 23 is formed with a two-layer winding portion including the first winding portion 71 and the second winding portion 72. As described later, each of the first winding portion 71 and the second winding portion 72 includes both a primary winding and a secondary winding.

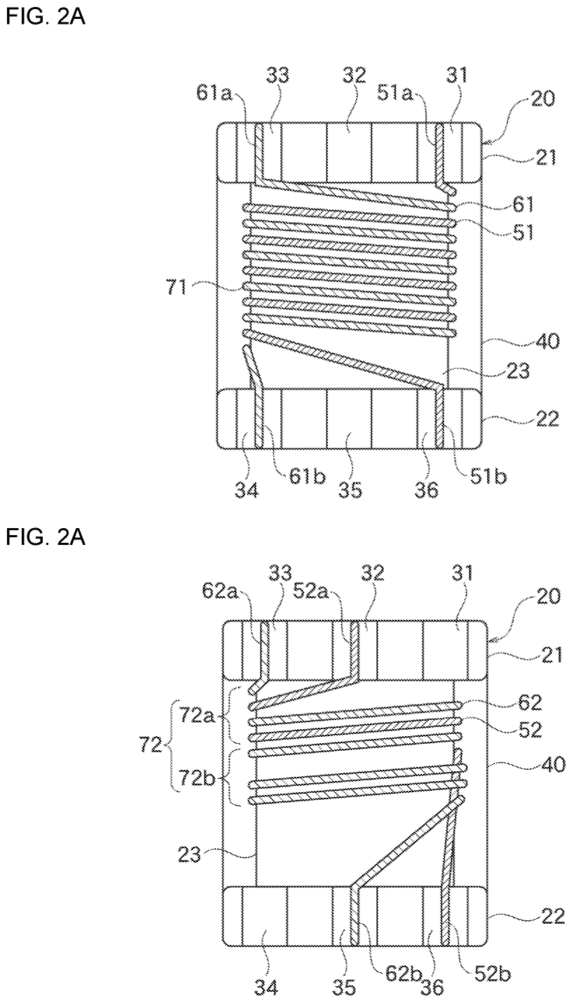

As illustrated in FIG. 2A, the first winding portion 71 is formed by winding a pair of a first primary wire 51 and a first secondary wire 61 around the winding core portion 23. The first primary wire 51 and the first secondary wire 61 have substantially the same wire length and are wound in five turns around the outer peripheral surface of the winding core portion 23. In the illustrated example, the number of turns of the first primary wire 51 and the number of turns of the first secondary wire 61 are equal to each other.

In the first winding portion 71 of the present embodiment, the first primary wire 51 and the first secondary wire 61 are alternately disposed and wound. The first primary wire 51 and the first secondary wire 61 are wound in the same direction in the first winding portion 71.

In the illustrated example, the first primary wire 51 and the first secondary wire 61 are wound (disposed) apart from each other in the winding axis direction (X-axis direction) so that the drawing is easier to see. However, it is preferable that the first primary wire 51 and the first secondary wire 61 are wound in close contact with each other (without a gap). In this case, a magnetic flux is likely to be interlinked with the first winding portion 71.

A first lead portion 51a constituting one end of the first primary wire 51 is connected to the first terminal electrode 31 by, for example, thermocompression bonding. A second lead portion 51b constituting the other end of the first primary wire 51 is connected to the sixth terminal electrode 36 by, for example, thermocompression bonding.

A first lead portion 61a constituting one end of the first secondary wire 61 is connected to the third terminal electrode 33 by, for example, thermocompression bonding. A second lead portion 61b constituting the other end of the first secondary wire 61 is connected to the fourth terminal electrode 34 by, for example, thermocompression bonding.

As illustrated in FIG. 2B, the second winding portion 72 is formed by winding a pair of a second primary wire 52 and a second secondary wire 62 around the winding core portion 23. In the second winding portion 72, the wire lengths of the second primary wire 52 and the second secondary wire 62 are different from each other and the wire length of the second secondary wire 62 exceeds the wire length of the second primary wire 52. It should be noted that the second winding portion 72 is illustrated in FIG. 2B and the first winding portion 71 is not illustrated in FIG. 2B so that the drawing is prevented from becoming complicated. In addition, the wire lengths of the second primary wire 52 and the second secondary wire 62 may be substantially equal to each other.

In the second winding portion 72, the number of turns of the second primary wire 52 and the number of turns of the second secondary wire 62 are different from each other. More specifically, the number of turns of the second secondary wire 62 is five, the number of turns of the second primary wire 52 is two, and the number of turns of the second secondary wire 62 exceeds the number of turns of the second primary wire 52.

In the second winding portion 72, the second primary wire 52 and the second secondary wire 62 are wound in the same direction. In addition, the winding directions of the windings 52 and 62 in the second winding portion 72 and the winding directions of the windings 51 and 61 in the first winding portion 71 are directions in which the direction of the magnetic flux that is generated when a current flows through the first winding portion 71 and the direction of the magnetic flux that is generated when a current flows through the second winding portion 72 are aligned.

The second winding portion 72 is formed with an alternating winding region 72a where the second primary wire 52 and the second secondary wire 62 are alternately disposed in the winding axis direction and wound and a continuous winding region 72b where the second secondary wire 62 is continuously wound. In the illustrated example, the alternating winding region 72a is formed on the side where the first flange portion 21 is disposed and the continuous winding region 72b is formed on the side where the second flange portion 22 is disposed. Alternatively, the disposition thereof may be reversed.

The alternating winding region 72a have the second primary wire 52 and the second secondary wire 62 wound around the winding core portion 23 in two turns each. In the alternating winding region 72a, the second primary wire 52 and the second secondary wire 62 are alternately disposed in the winding axis direction and the number of turns of the second primary wire 52 and the number of turns of the second secondary wire 62 are equal to each other.

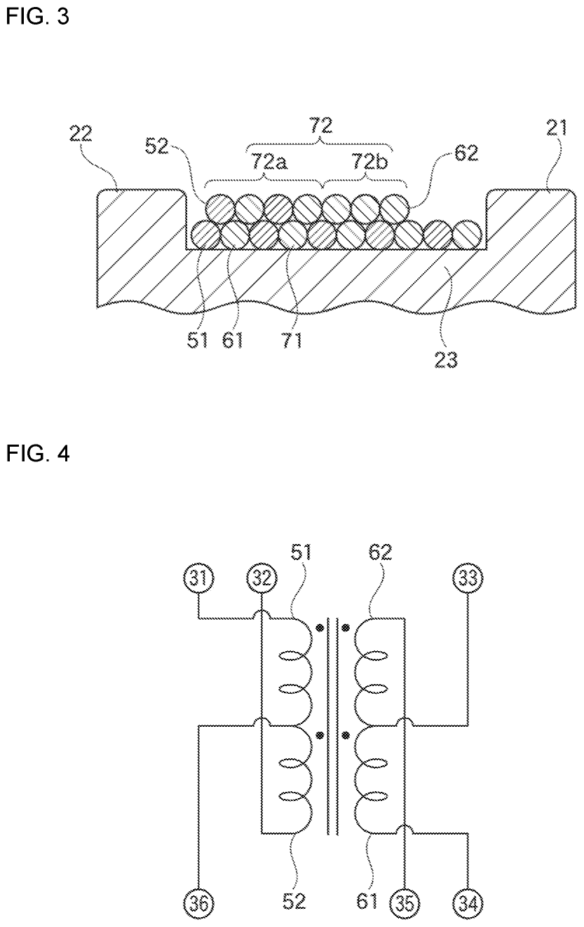

In the illustrated example, the second primary wire 52 and the second secondary wire 62 are wound (disposed) apart from each other in the winding axis direction so that the drawing is easier to see. However, it is preferable that the second primary wire 52 and the second secondary wire 62 in the alternating winding region 72a are wound in close contact with each other (without a gap) as illustrated in FIG. 3. In this case, a magnetic flux is likely to be interlinked with the second winding portion 72.

As illustrated in FIG. 2B, the continuous winding region 72b has the second secondary wire 62 wound in three turns around the winding core portion 23. The second secondary wire 62 constitutes the continuous winding region 72b on its own. In the continuous winding region 72b, each turn of the second secondary wire 62 is continuously disposed and the second secondary wire 62 constitutes the first to third turns constituting the continuous winding region 72b.

The continuous winding region 72b is disposed adjacent to the alternating winding region 72a in the winding axis direction, and the end portion of the second secondary wire 62 in the continuous winding region 72b (end portion on the alternating winding region 72a side) is continuous with the end portion of the second secondary wire 62 in the alternating winding region 72a (end portion on the continuous winding region 72b side). In other words, the continuous winding region 72b is electrically connected to the alternating winding region 72a.

In the illustrated example, the second secondary wire 62 is wound (disposed) apart in the winding axis direction so that the drawing is easier to see. However, it is preferable that the turns of the second secondary wire 62 in the continuous winding region 72b are wound in close contact with each other (without a gap) as illustrated in FIG. 3. In this case, a magnetic flux is likely to be interlinked with the second winding portion 72.

In addition, the continuous winding region 72b is formed in close contact (without a gap) with the alternating winding region 72a in the winding axis direction and the second secondary wire 62 in the continuous winding region 72b is wound in close contact (without a gap) with the second secondary wire 62 in the alternating winding region 72a. The same winding (second secondary wire 62 in the present embodiment) is disposed adjacent to the boundary part between the continuous winding region 72b and the alternating winding region 72a.

The number of turns (three) of the second secondary wire 62 in the continuous winding region 72b exceeds the number of turns (two) of the second secondary wire 62 in the alternating winding region 72a and is exceeded by the total number of turns (four) of the second primary wire 52 and the second secondary wire 62 in the alternating winding region 72a.

As illustrated in FIG. 2B, a first lead portion 52a constituting one end of the second primary wire 52 is connected to the second terminal electrode 32 by, for example, thermocompression bonding. A second lead portion 52b constituting the other end of the second primary wire 52 is connected to the sixth terminal electrode 36 by, for example, thermocompression bonding.

A first lead portion 62a constituting one end of the second secondary wire 62 is connected to the third terminal electrode 33 by, for example, thermocompression bonding. A second lead portion 62b constituting the other end of the second secondary wire 62 is connected to the fifth terminal electrode 35 by, for example, thermocompression bonding.

In other words, in the present embodiment, the second lead portion 51b of the first primary wire 51 and the second lead portion 52b of the second primary wire 52 are connected to the sixth terminal electrode 36 and the second lead portion 51b and the second lead portion 52b are connected via the sixth terminal electrode 36 (conductive member) as illustrated in FIGS. 2A and 2B. Accordingly, the first primary wire 51 and the second primary wire 52 are electrically connected.

In addition, the first lead portion 61a of the first secondary wire 61 and the first lead portion 62a of the second secondary wire 62 are connected via the third terminal electrode 33 and the first lead portion 61a and the first lead portion 62a are connected via the third terminal electrode 33 (conductive member). Accordingly, the first secondary wire 61 and the second secondary wire 62 are electrically connected.

Accordingly, as illustrated in FIG. 4, the first primary wire 51 and the second primary wire 52 are connected in series to constitute the primary side of the coil device 10 (balun transformer) and the first secondary wire 61 and the second secondary wire 62 are connected in series to constitute the secondary side of the coil device 10 (balun transformer). In addition, the connection part between the first primary wire 51 and the second primary wire 52 is an intermediate tap and the connection part between the first secondary wire 61 and the second secondary wire 62 is also an intermediate tap.

Next, a method for manufacturing the coil device 10 will be described with reference to FIGS. 1, 2A, and 2B. In manufacturing the coil device 10, the drum-type drum core 20, the first primary wire 51, the first secondary wire 61, the second primary wire 52, and the second secondary wire 62 are prepared first. It should be noted that what is obtained by covering a core material made of a good conductor such as copper (Cu) with an insulating material made of imide-modified polyurethane or the like and covering the outermost surface with a thin resin film such as polyester can be used as an example of the windings 51, 52, 61, and 62.

Examples of the magnetic material constituting the drum core 20 include a metal magnetic material and a magnetic material relatively high in magnetic permeability such as Ni—Zn-based ferrite and Mn—Zn-based ferrite. The drum core 20 is produced by molding and sintering powders of these magnetic materials.

Next, metal paste is applied to the flange portions 21 and 22 of the drum core 20 and baking is performed at a predetermined temperature. Then, the terminal electrodes 31 to 36 are formed by performing electric field plating or electroless plating on the surface thereof.

Next, the drum core 20, the first primary wire 51, and the first secondary wire 61 are set in a winding machine (not illustrated) with the terminal electrodes 31 to 36 formed. Then, the first lead portion 51a of the first primary wire 51 is connected to the first terminal electrode 31. At the same time (or subsequently), the first lead portion 61a of the first secondary wire 61 is connected to the third terminal electrode 33.

It should be noted that methods for the connection are not particularly limited. As an example, a heater tip is pressed so as to sandwich the wires 51 and 61 with the terminal electrodes 31 and 33 and the wires 51 and 61 are thermocompression-bonded to the terminal electrodes 31 and 33.

Subsequently, the wires 51 and 61 are wound around the outer peripheral surface of the winding core portion 23 in, for example, five turns each. The first winding portion 71 is formed as a result. The first winding portion 71 is formed by, for example, winding the first primary wire 51 and the first secondary wire 61 around the winding core portion 23 in a paired state.

Next, the second lead portion 51b of the first primary wire 51 is connected to the sixth terminal electrode 36. At the same time (or subsequently), the second lead portion 61b of the first secondary wire 61 is connected to the fourth terminal electrode 34.

Next, the first lead portion 52a of the second primary wire 52 is connected to the second terminal electrode 32. At the same time (or subsequently), the first lead portion 62a of the second secondary wire 62 is connected to the third terminal electrode 33.

Subsequently, the windings 52 and 62 are wound on the first winding portion 71 and the second winding portion 72 is formed as a result. At this time, the alternating winding region 72a is formed by, for example, winding the second primary wire 52 and the second secondary wire 62 on the first winding portion 71 in a paired state and in, for example, two turns.

After the formation of the alternating winding region 72a, the second lead portion 52b of the second primary wire 52 is pulled out to the sixth terminal electrode 36 and connected to the sixth terminal electrode 36. Meanwhile, the second secondary wire 62 is wound continuously and as it is on the first winding portion 71 in, for example, three turns even after the formation of the alternating winding region 72a. The continuous winding region 72b is formed as a result. Subsequently, the second lead portion 62b of the second secondary wire 62 is pulled out to the fifth terminal electrode 35 and connected to the fifth terminal electrode 35.

It should be noted that the second secondary wire 62 after the formation of the alternating winding region 72a may be wound as it is on the first winding portion 71 in, for example, three turns to form the continuous winding region 72b and then the second lead portion 52b of the second primary wire 52 may be pulled out to the sixth terminal electrode 36 and connected to the sixth terminal electrode 36.

Next, the coil device 10 can be obtained by installing the plate core 40 on the lower surfaces 21b and 22b of the flange portions 21 and 22. The lower surfaces 21b and 22b are flat, and thus the plate core 40 is installed with ease. It is preferable that the same magnetic material member as the drum core 20 constitutes the plate core 40. Alternatively, separate members may constitute the drum core 20 and the plate core 40.

In the coil device 10 according to the present embodiment, the second winding portion 72 is formed with the alternating winding region 72a where the second primary wire 52 and the second secondary wire 62 are alternately disposed and wound and the continuous winding region 72b where either the second primary wire 52 or the second secondary wire 62 (second secondary wire 62 in the present embodiment) is continuously wound. In the case of such a winding method (formation of the alternating winding region 72a as well as the continuous winding region 72b in the second winding portion 72), the second winding portion 72 is provided with a region where the second primary wire 52 and the second secondary wire 62 are adjacent to each other and, in the alternating winding region 72a, each of the alternately disposed second primary wire 52 and second secondary wire 62 (adjacent to each other) is strongly coupled. Accordingly, in a high frequency band of, for example, 100 MHz or more, the coupling coefficient between the primary windings 51 and 52 and the secondary windings 61 and 62 can be increased and a satisfactory magnetic coupling can be obtained between the primary windings 51 and 52 and the secondary windings 61 and 62. As a result, according to the present embodiment, it is possible to realize the coil device 10 with little insertion loss and a reduced leakage inductance in a high frequency band.

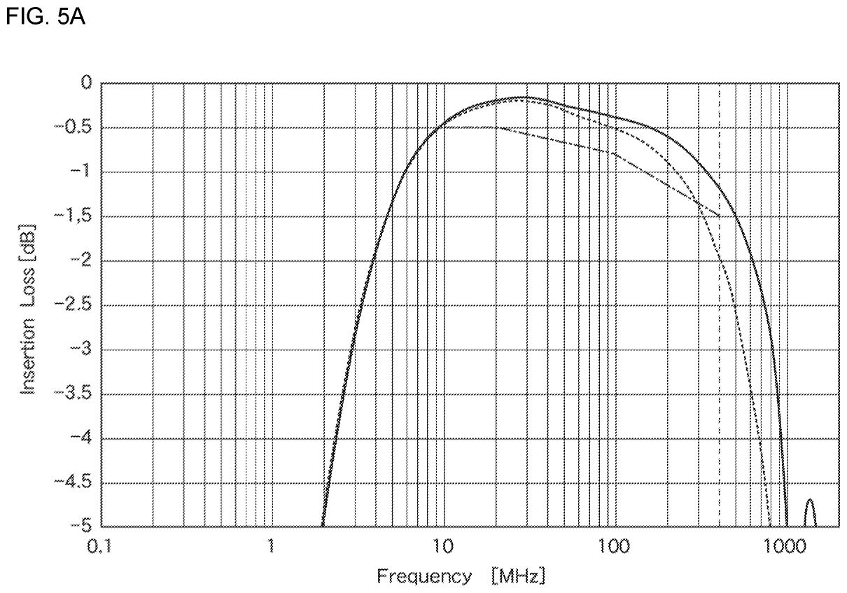

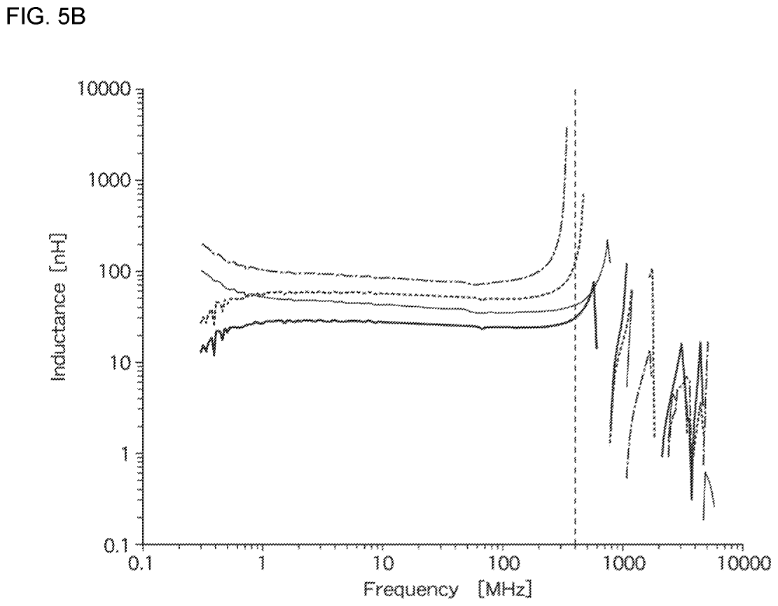

In FIG. 5A, the solid line indicates the frequency characteristic of the insertion loss of the coil device 10 according to the present embodiment, the dotted line indicates the frequency characteristic of the insertion loss of the coil device of the related art, and the one-dot chain line indicates the frequency characteristic of transmission line insertion loss. As shown in the drawing, in the coil device 10 according to the present embodiment, the insertion loss is approximately −1.2 dB even at, for example, 400 MHz. It can be seen that the insertion loss in a high frequency band is smaller in the coil device 10 than in the coil device of the related art.

In FIG. 5B, the thick solid line indicates the frequency characteristic of the primary leakage inductance of the coil device 10 according to the present embodiment and the thin solid line indicates the frequency characteristic of the primary leakage inductance of the coil device of the related art. In addition, the dotted line indicates the frequency characteristic of the secondary leakage inductance of the coil device 10 according to the present embodiment and the one-dot chain line indicates the frequency characteristic of the secondary leakage inductance of the coil device of the related art. As shown in the drawing, it can be seen that both the primary leakage inductance and the secondary leakage inductance in a high frequency band of, for example, 100 MHz to 400 MHz are smaller in the coil device 10 according to the present embodiment than in the coil device of the related art. From the above and according to the present embodiment, it is possible to realize the coil device 10 with little insertion loss and a reduced leakage inductance in a high frequency band.

In addition, in the first winding portion 71 of the present embodiment, the first primary wire 51 and the first secondary wire 61 are alternately disposed and wound. Accordingly, in the first winding portion 71, each of the first primary wire 51 and the first secondary wire 61 disposed adjacent to each other is strongly coupled. Accordingly, in the first winding portion 71, a satisfactory magnetic coupling can be obtained between the first primary wire 51 and the first secondary wire 61, and the insertion loss in a high frequency band can be effectively reduced.

In addition, in the present embodiment, the second winding portion 72 is formed on the first winding portion 71. In a case where the number of turns in the second winding portion 72 is smaller than the number of turns in the first winding portion 71, the winding portion formed in the upper layer is less likely to collapse when the second winding portion 72 is formed on the first winding portion 71 than when the first winding portion 71 is formed on the second winding portion 72 and each of the winding portions 71 and 72 can be stably formed.

In addition, in the second winding portion 72 of the present embodiment, the number of turns of either the second primary wire 52 or the second secondary wire 62 (second secondary wire 62 in the present embodiment) exceeds the number of turns of the other. Accordingly, it is possible to form the continuous winding region 72b in the second winding portion 72 by using the second secondary wire 62 larger in number of turns and form the alternating winding region 72a in the second winding portion 72 by using the second primary wire 52 smaller in number of turns. As a result, the coupling coefficient between the primary windings 51 and 52 and the secondary windings 61 and 62 can be increased and a satisfactory magnetic coupling can be obtained between the primary windings 51 and 52 and the secondary windings 61 and 62.

In addition, in the second winding portion 72 of the present embodiment, the wire length of either the second primary wire 52 or the second secondary wire 62 (second secondary wire 62 in the present embodiment) exceeds the wire length of the other. Accordingly, it is possible to form the continuous winding region 72b in the second winding portion 72 by using the second secondary wire 62 longer in wire length and form the alternating winding region 72a in the second winding portion 72 by using the second primary wire 52 shorter in wire length. As a result, the coupling coefficient between the primary windings 51 and 52 and the secondary windings 61 and 62 can be increased and a satisfactory magnetic coupling can be obtained between the primary windings 51 and 52 and the secondary windings 61 and 62.

In addition, in the present embodiment, one end (second lead portion 51b) of the first primary wire 51 and one end (second lead portion 52b) of the second primary wire 52 are connected via the conductive member (sixth terminal electrode 36) and one end (first lead portion 61a) of the first secondary wire 61 and one end (first lead portion 62a) of the second secondary wire 62 are connected via the conductive member (third terminal electrode 33). Accordingly, each of the connection portion between the first primary wire 51 and the second primary wire 52 and the connection portion between the first secondary wire 61 and the second secondary wire 62 can be used as an intermediate tap.

In addition, the second primary wire 52 and the second secondary wire 62 are wound in close contact with each other in the alternating winding region 72a of the present embodiment and the turns of the second secondary wire 62 are wound in close contact with each other in the continuous winding region 72b of the present embodiment (see FIG. 3). Accordingly, a magnetic flux is likely to be interlinked with the second winding portion 72 in each of the winding regions 72a and 72b and the magnetic coupling between the primary windings 51 and 52 and the secondary windings 61 and 62 can be enhanced.

In addition, in the present embodiment, the alternating winding region 72a and the continuous winding region 72b are formed in close contact with each other (see FIG. 3). Accordingly, the turns adjacent to each other in the winding axis direction are wound in close contact with each other in the entire second winding portion 72, and thus the magnetic coupling between the primary windings 51 and 52 and the secondary windings 61 and 62 can be effectively enhanced.

### Second Embodiment

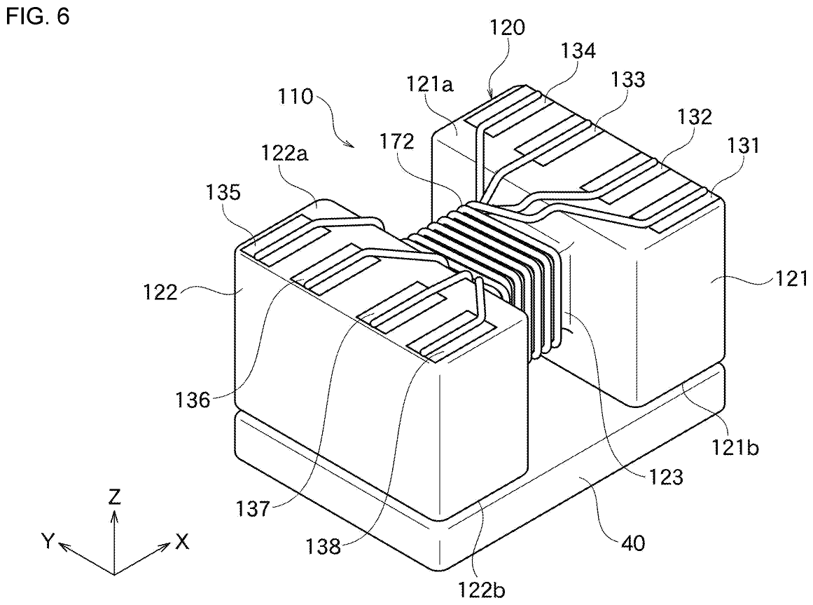

A coil device 110 according to the second embodiment of the present invention illustrated in FIGS. 6 to 9 differs only in the following points, and the rest of its configuration is the same as that of the first embodiment described above. In the drawings, members common to the first and second embodiments are denoted by the same reference numerals with redundant detailed description omitted.

As illustrated in FIG. 6, the coil device 110 differs from the coil device 10 in the first embodiment in that the coil device 110 has a drum core 120, terminal electrodes 131 to 138, and a second winding portion 172. The drum core 120 has a first flange portion 121, a second flange portion 122, and a winding core portion 123.

The flange portions 121 and 122 differ from the flange portions 21 and 22 in the first embodiment in that the thickness of the flange portions 121 and 122 in the X-axis direction exceeds the thickness of the flange portions 21 and 22 in the X-axis direction. The winding core portion 123 differs from the winding core portion 23 in the first embodiment in that the lengths of the winding core portion 123 in the X-axis direction and the Y-axis direction are exceeded by the lengths of the flange portions 21 and 22 in the X-axis direction and the Y-axis direction, respectively.

On an upper surface 121a of the first flange portion 121, the first terminal electrode 131, the second terminal electrode 132, the third terminal electrode 133, and the fourth terminal electrode 134 are respectively formed at predetermined intervals in the Y-axis direction. On an upper surface 122a of the second flange portion 122, the fifth terminal electrode 135, the sixth terminal electrode 136, the seventh terminal electrode 137, and the eighth terminal electrode 138 are respectively formed at predetermined intervals in the Y-axis direction.

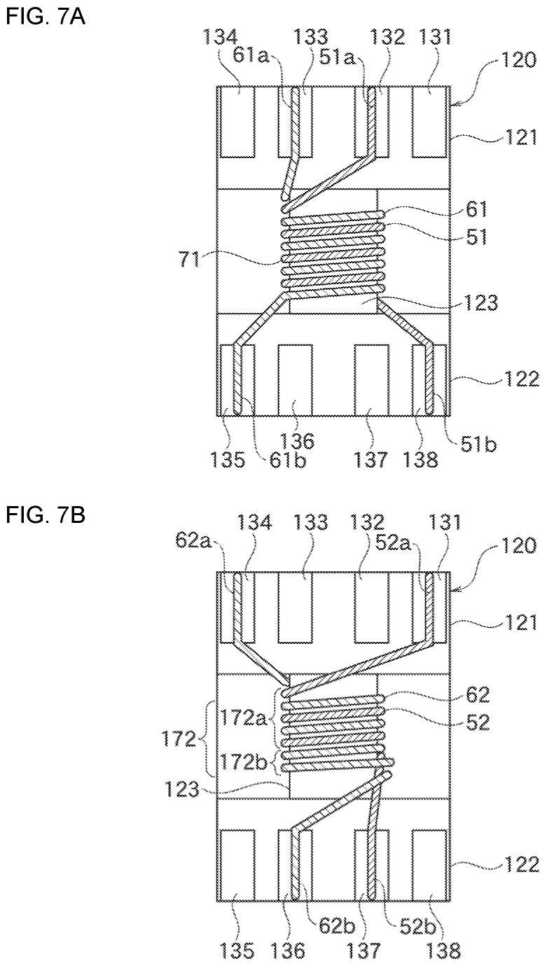

As illustrated in FIG. 7A, the first lead portion 51a of the first primary wire 51 is connected to the second terminal electrode 132 and the second lead portion 51b is connected to the eighth terminal electrode 138. The first lead portion 61a of the first secondary wire 61 is connected to the third terminal electrode 133, and the second lead portion 61b is connected to the fifth terminal electrode 135.

As illustrated in FIG. 7B, the first lead portion 52a of the second primary wire 52 is connected to the first terminal electrode 131 and the second lead portion 52b is connected to the seventh terminal electrode 137. The first lead portion 62a of the second secondary wire 62 is connected to the fourth terminal electrode 134, and the second lead portion 62b is connected to the sixth terminal electrode 136.

In the present embodiment, the first terminal electrode 131 and the eighth terminal electrode 138 are connected by a land pattern on a circuit board and the fourth terminal electrode 134 and the fifth terminal electrode 135 are connected by a land pattern on the circuit board. Accordingly, the first primary wire 51 and the second primary wire 52 are electrically connected and the first secondary wire 61 and the second secondary wire 62 are electrically connected.

Accordingly, as illustrated in FIG. 9, the first primary wire 51 and the second primary wire 52 are connected in series to constitute the primary side of the coil device 10 (balun transformer) and the first secondary wire 61 and the second secondary wire 62 are connected in series to constitute the secondary side of the coil device 10 (balun transformer). In addition, the connection part between the first primary wire 51 and the second primary wire 52 (that is, the connection part between the first terminal electrode 131 and the eighth terminal electrode 138) serves as an intermediate tap. Likewise, the connection part between the first secondary wire 61 and the second secondary wire 62 (that is, the connection part between the fourth terminal electrode 134 and the fifth terminal electrode 135) serves as an intermediate tap.

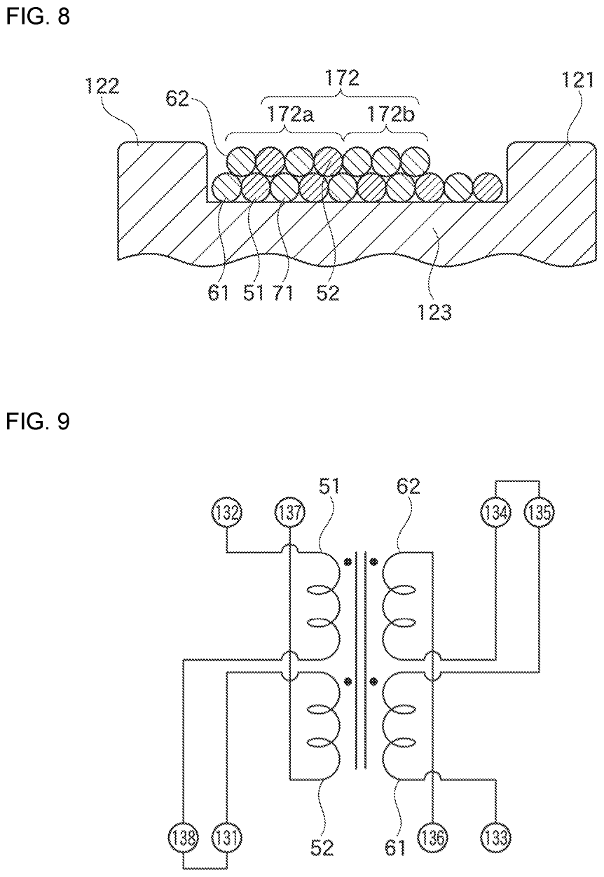

As illustrated in FIG. 7B, the second winding portion 172 has an alternating winding region 172a and a continuous winding region 172b. As illustrated in FIG. 8, in the alternating winding region 172a, the second primary wire 52 and the second secondary wire 62 are wound on the first winding portion 71 in two turns each. In the continuous winding region 172b, the second secondary wire 62 is wound in three turns on the first winding portion 71.

It should be noted that the first secondary wire 61 in the first winding portion 71 of the present embodiment is disposed on the second flange portion 122 side unlike in the first embodiment and the first primary wire 51 and the first secondary wire 61 are wound as a pair. In addition, in the alternating winding region 72a, the second primary wire 52 and the second secondary wire 62 are wound as a pair with the second secondary wire 62 disposed on the second flange portion 122 side.

As described above, the numbers of turns of the second primary wire 52 and the second secondary wire 62 may be appropriately changed in the alternating winding region 172a and the number of turns of the second secondary wire 62 may be appropriately changed in the continuous winding region 172b. In this case as well, the same effect as in the first embodiment can be obtained.

It should be noted that the present invention is not limited to the embodiments described above and can be variously modified within the scope of the present invention.

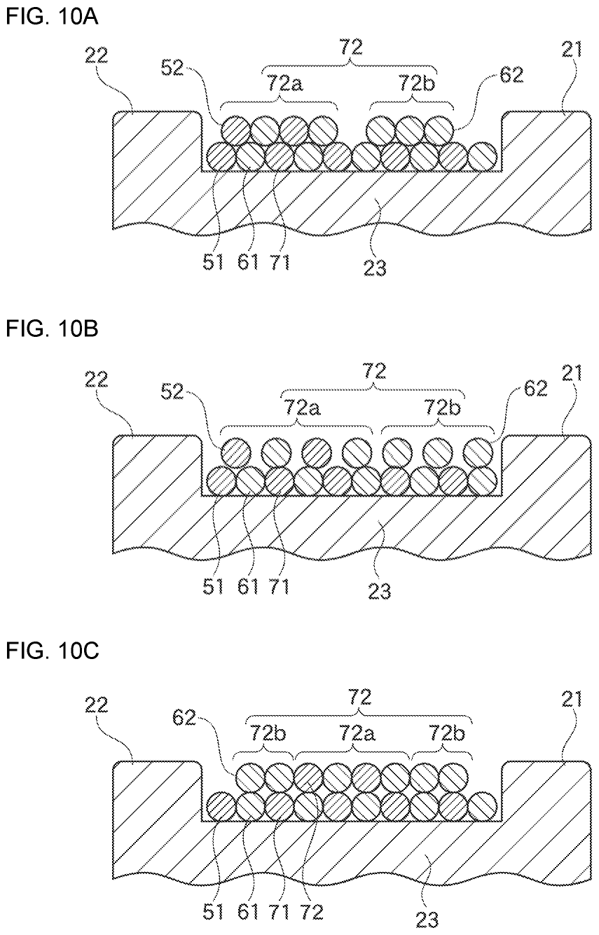

In each of the embodiments described above, the configuration of the second winding portion 72, 172 may be appropriately changed without being limited to the configuration illustrated in FIG. 3 or 8. For example, the alternating winding region 72a and the continuous winding region 72b may be formed apart from each other as illustrated in FIG. 10A. In the illustrated example, a gap of one winding (second primary wire 52 or second secondary wire 62) is formed between the alternating winding region 72a and the continuous winding region 72b. It should be noted that the width of the gap is not particularly limited and may be appropriately changed.

In addition, in the alternating winding region 72a, the second primary wire 52 and the second secondary wire 62 may be wound apart from each other in the winding axis direction as illustrated in FIG. 10B. In addition, in the continuous winding region 72b, the turns of the second secondary wire 62 may be wound apart from each other in the winding axis direction. In the illustrated example, a gap of 0.5 to 1 winding is formed between the turns in both the alternating winding region 72a and the continuous winding region 72b. In addition, a similar gap is formed between the alternating winding region 72a and the continuous winding region 72b. It should be noted that the width of the gap is not particularly limited and may be appropriately changed.

In addition, as illustrated in FIG. 10C, the continuous winding region 72b may be formed so as to straddle one side and the other side of the alternating winding region 72a in the winding axis direction. In the illustrated example, the continuous winding region 72b is disposed on one side and the other side in the winding axis direction with respect to the alternating winding region 72a and the alternating winding region 72a is sandwiched between the two continuous winding regions 72b. Each continuous winding region 72b is formed by the second secondary wire 62 wound in two turns and is connected via the alternating winding region 72a.

In each of the embodiments described above, the number of turns of each of the first primary wire 51 and the first secondary wire 61 in the first winding portion 71 is not particularly limited and may be appropriately changed. In addition, the numbers of turns of the second primary wire 52 and the second secondary wire 62 constituting the alternating winding region 72a in the second winding portion 72 are not particularly limited and may be appropriately changed. The same applies to the number of turns of the second primary wire 52 or the second secondary wire 62 constituting the continuous winding region 72b. For example, in FIG. 2B, the continuous winding region 72b may be configured by winding the second secondary wire 62 in one turn. In this case, the second secondary wire 62 is disposed continuously with respect to the final turn part of the second secondary wire 62 in the alternating winding region 72a.

In each of the embodiments described above, the winding core portion 23 is formed with the two-layer winding portion including the first winding portion 71 and the second winding portion 72. Alternatively, the number of layers of the winding portion formed in the winding core portion 23 is not limited to two and may be three or more. In this case, it is preferable that the winding portion of the outermost layer is provided with the alternating winding region 72a and the continuous winding region 72b.

As illustrated in FIG. 3, in each of the embodiments described above, the first primary wire 51 and the second primary wire 52 are wound in seven turns in total and the first secondary wire 61 and the second secondary wire 62 are wound in 10 turns in total. However, the number of turns of each of the windings is not particularly limited. For example, T1:T2, which is the ratio of a total number of turns T1 of the first primary wire 51 and the second primary wire 52 to a total number of turns T2 of the first secondary wire 61 and the second secondary wire 62, may be 10:14 or 12:17 or the like and may be 14:10 or 17:12 or the like. In this case, the winding smaller in number of turns is paired with the winding larger in number of turns to constitute the first winding portion 71 and the alternating winding region 72a. In addition, the winding larger in number of turns constitutes the continuous winding region 72b.

In each of the embodiments described above, the first winding portion 71 is formed directly on the outer peripheral surface of the winding core portion 23 and the second winding portion 72 is formed on the first winding portion 71. Alternatively, the second winding portion 72 may be formed directly on the outer peripheral surface of the winding core portion 23 and the first winding portion 71 may be formed on the second winding portion 72.

Although the wire length of the second secondary wire 62 exceeds the wire length of the second primary wire 52 in each of the embodiments described above, the wire length of the second primary wire 52 may exceed the wire length of the second secondary wire 62. In this case, the continuous winding region 72b where the second primary wire 52 is continuously wound is formed and the turns of the second primary wire 52 are wound in close contact with each other in the continuous winding region 72b.

Although the number of turns of the second secondary wire 62 exceeds the number of turns of the second primary wire 52 in each of the embodiments described above, the number of turns of the second primary wire 52 may exceed the number of turns of the second secondary wire 62. In this case, the continuous winding region 72b where the second primary wire 52 is continuously wound is formed and the turns of the second primary wire 52 are wound in close contact with each other in the continuous winding region 72b.

Each of the embodiments described above may lack the plate core 40. In addition, the terminal electrodes 31 to 36 and 131 to 138 may be made of a conductive plate material (metal terminal).

Although an example of application of the coil device 10 according to the present invention to a balun transformer has been described in each of the embodiments described above, the present invention may be applied to other coil devices.

In the first embodiment, the shapes of the terminal electrodes 31 to 36 are not particularly limited and the shapes may or may not be identical. In addition, in the second embodiment, the shapes of the terminal electrodes 131 to 138 are not particularly limited and the shapes may or may not be identical.

In each of the embodiments described above, the shapes of the terminal electrodes 31 to 36 and 131 to 138 may be appropriately changed depending on how the lead portions 51a, 51b, 61a, 61b, 52a, 52b, 62a, and 62b are pulled out or in order to ensure an inter-terminal distance for each of the terminal electrodes 31 to 36 and 131 to 138. For example, the terminal electrodes 31 and 33 may be formed so as to straddle the side surface (or the outer end surface and the side surface) of the first flange portion 21 and the upper surface 21a and the terminal electrodes 34 and 36 may be formed so as to straddle the side surface (or the outer end surface and the side surface) of the second flange portion 22 and the upper surface 22a. In addition, in the second embodiment, the terminal electrodes 131 and 134 may be formed so as to straddle the side surface (or the outer end surface and the side surface) of the first flange portion 121 and the upper surface 121a and the terminal electrodes 135 and 138 may be formed so as to straddle the side surface (or the outer end surface and the side surface) of the second flange portion 122 and the upper surface 122a.

What is claimed is:

1. A coil device comprising:
a core having a winding core portion and a flange portion formed in an end portion of the winding core portion;
a first winding portion formed by winding a first primary wire and a first secondary wire around the winding core portion; and
a second winding portion formed by winding a second primary wire and a second secondary wire around the winding core portion,
wherein the second winding portion is formed with an alternating winding region where the second primary wire and the second secondary wire are alternately disposed and wound and a continuous winding region where either the second primary wire or the second secondary wire is continuously wound.

2. The coil device according to claim 1, wherein the first primary wire and the first secondary wire are alternately disposed and wound in the first winding portion.

3. The coil device according to claim 1, wherein the second winding portion is formed on the first winding portion.

4. The coil device according to claim 2, wherein the second winding portion is formed on the first winding portion.

5. The coil device according to claim 1, wherein the number of turns of either the second primary wire or the second secondary wire exceeds the number of turns of the other in the second winding portion.

6. The coil device according to claim 2, wherein the number of turns of either the second primary wire or the second secondary wire exceeds the number of turns of the other in the second winding portion.

7. The coil device according to claim 1, wherein a wire length of either the second primary wire or the second secondary wire exceeds a wire length of the other in the second winding portion.

8. The coil device according to claim 2, wherein a wire length of either the second primary wire or the second secondary wire exceeds a wire length of the other in the second winding portion.

9. The coil device according to claim 1, wherein one end of the first primary wire and one end of the second primary wire are connected via a conductive member and one end of the first secondary wire and one end of the second secondary wire are connected via a conductive member.

10. The coil device according to claim 2, wherein one end of the first primary wire and one end of the second primary wire are connected via a conductive member and one end of the first secondary wire and one end of the second secondary wire are connected via a conductive member.

11. The coil device according to claim 1, wherein
the second primary wire and the second secondary wire are wound in close contact with each other in the alternating winding region, and
each turn of the second primary wire or each turn of the second secondary wire is wound in close contact in the continuous winding region.

12. The coil device according to claim 2, wherein
the second primary wire and the second secondary wire are wound in close contact with each other in the alternating winding region, and
each turn of the second primary wire or each turn of the second secondary wire is wound in close contact in the continuous winding region.

13. The coil device according to claim 11, wherein the alternating winding region and the continuous winding region are formed in close contact with each other.

14. The coil device according to claim 12, wherein the alternating winding region and the continuous winding region are formed in close contact with each other.

15. The coil device according to claim 1, wherein
the second primary wire and the second secondary wire are wound apart from each other in a winding axis direction in the alternating winding region, and
each turn of the second primary wire or each turn of the second secondary wire is wound apart in the winding axis direction in the continuous winding region.

16. The coil device according to claim 2, wherein
the second primary wire and the second secondary wire are wound apart from each other in a winding axis direction in the alternating winding region, and
each turn of the second primary wire or each turn of the second secondary wire is wound apart in the winding axis direction in the continuous winding region.

17. The coil device according to claim 1, wherein the continuous winding region is formed so as to straddle one side and the other side of the alternating winding region in a winding axis direction.

18. The coil device according to claim 2, wherein the continuous winding region is formed so as to straddle one side and the other side of the alternating winding region in a winding axis direction.
